(19) United States
(12) Patent Application Publication
(10) Pub. No.: US 2002/0000456 A1
(43) Pub. Date: Jan. 3, 2002

(54) Arrangement for transporting objects in a motor vehicle

(75) Inventors: Detlef Zimmermann, Schwerte (DE); Ralf Hoge, Radevormwald (DE)

Correspondence Address: Jeffrey S. Gundersen, FOLEY & LARDNER, Firstar Center, 777 East Wisconsin Avenue, Milwaukee, WI, 53202-5367, US

(73) Assignee: Johnson Controls Technology Company

(21) Appl. No.: 09/870,426

(22) Filed: May 30, 2001

(30) Foreign Application Priority Data
May 30, 2000 (DE) 200 09 661.3

(51) Int. Cl. B60R 9/00; B60R 11/00

(52) U.S. Cl. 224/498; 224/549; 220/7; 220/529

(57) ABSTRACT

The application pertains to a device intended for the transport of goods in a motor vehicle. It includes a container mountable on the floor of the trunk, and includes foldable, connected parts so that in a non-use position, the container parts rest flat on the trunk floor, while in the in-use position the container parts are raised, thus forming at least one loading facility.

### BACKGROUND OF THE INVENTION

The invention concerns an arrangement for transporting objects in a motor vehicle consisting of a holding container to be mounted on the bottom of the cargo hold of a motor vehicle.

An arrangement such as this is known from DE-GM 298 10 334, wherein the essentially tub-shaped holding container consists of the frame-like holding part, which can be mounted in the motor vehicle, and at least one partial container, which can be removed from the holding part to form an access opening in the area of a spare wheel compartment on the side of the motor vehicle.

DE-GM 298 16 248 describes an arrangement especially for the transportation of a bicycle in a motor vehicle. For this purpose, this arrangement consists of a holding part, which can be fixedly attached to the interior of the motor vehicle, with especially adapted mounting and fixing means for at least one bicycle.

An object of the invention is to provide a transportation arrangement of the kind described above, which allows an improved utilization variety with a good utilization comfort as well as a safe installation of almost any desired object to be transported (load).

According to the invention, this is achieved via the features of claim 1. Other advantageous embodiments of the invention are contained in the dependent claims.

### SUMMARY OF THE INVENTION

An exemplary embodiment of the invention relates to an arrangement for transporting objects in a motor vehicle. The arrangement includes a holding container mounted on a cargo hold bottom of the motor vehicle. The holding container includes a number of container parts, which are movably collapsibly connected to each other in such a way that the holding container is configured to be transferred from a condition when not in use, wherein the container parts lie essentially folded together flat on or in the plane of the cargo hold bottom, into a condition for use, wherein the assembled container parts form at least one holding compartment.

### BRIEF DESCRIPTION OF THE DRAWINGS

The invention will be further described with respect to a preferred exemplary embodiment shown in the drawing, wherein:

FIG. 1 is a view into a motor vehicle cargo hold with a transportation arrangement according to the invention in its condition when not in use;

FIG. 2 is a view similar to that of FIG. 1 during the transition into the condition for use;

FIG. 3 shows the transportation arrangement according to the invention in the condition for use in a first position; and

FIG. 4 shows the transportation arrangement in its condition for use in a second possible position within the cargo hold.

### DETAILED DESCRIPTION OF THE PREFERRED EMBODIMENTS

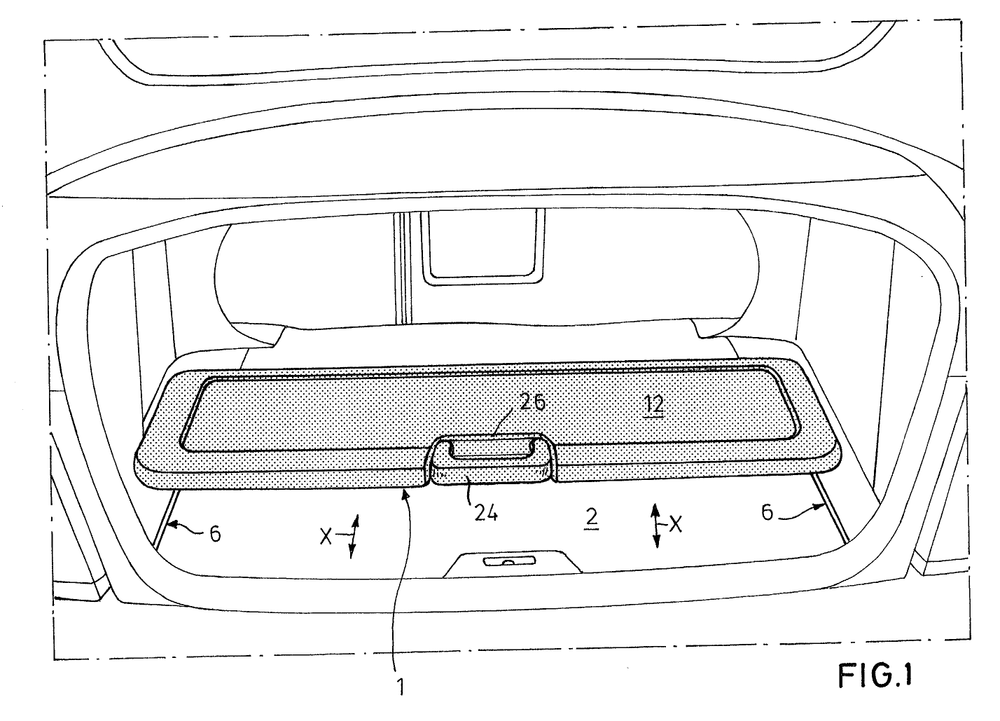

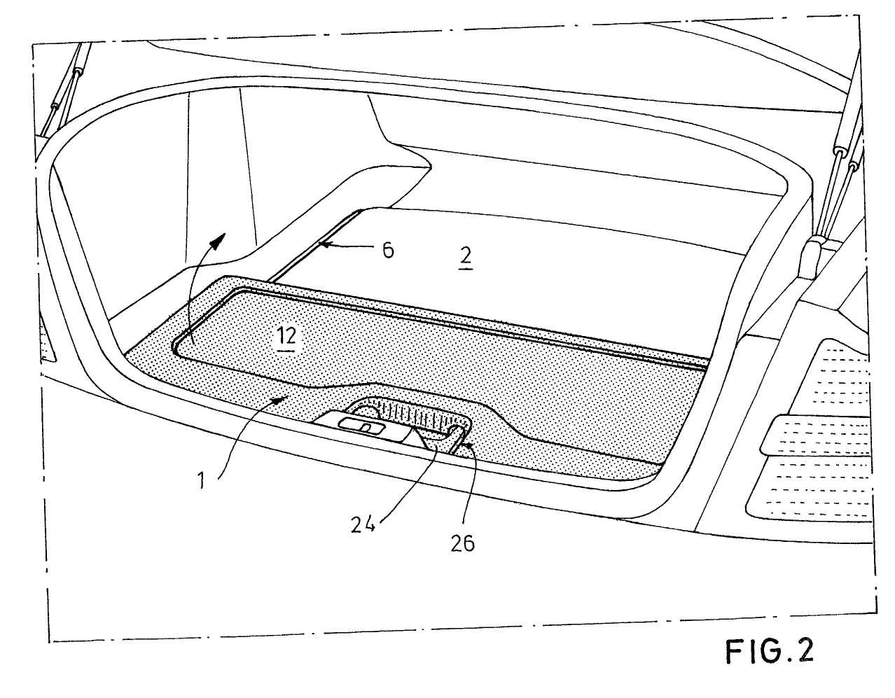

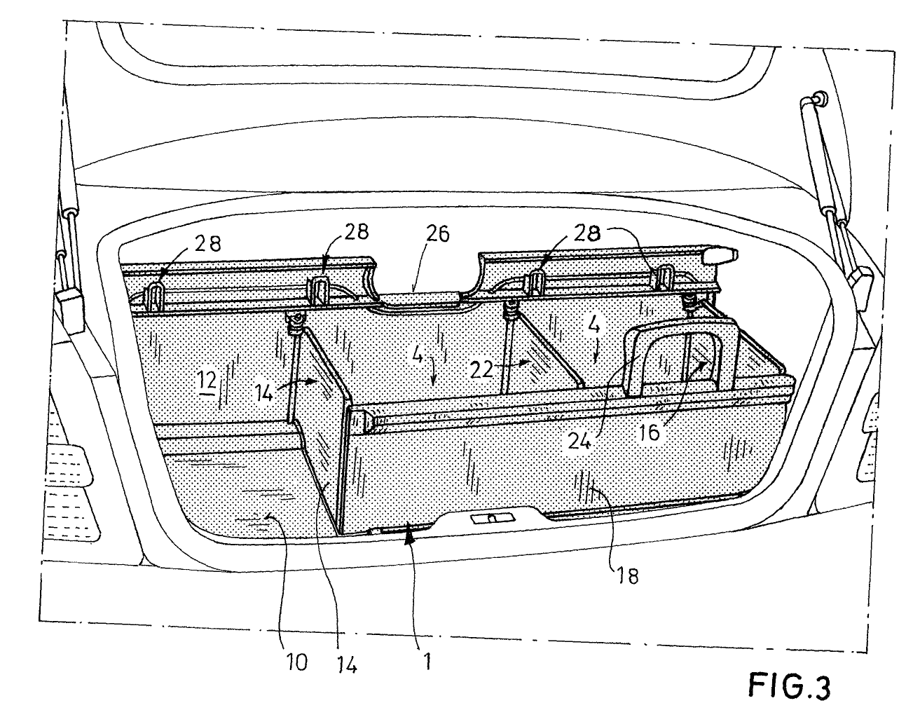

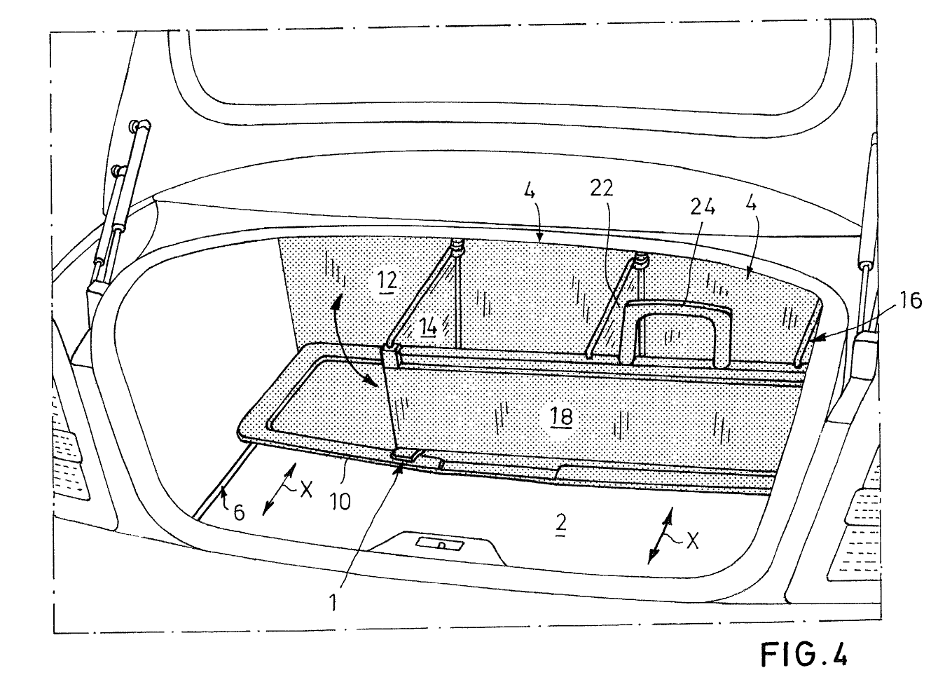

An arrangement according to the invention provided in a motor vehicle for transporting almost any desired object (not shown) consists of a holding container 1, which is mounted on a cargo hold bottom 2 of a motor vehicle. According to the invention, the holding container 1 consists of several container parts, which will be described in more detail in the following, which are movably foldably connected to each other in such a way that the holding container 1 is transferred from a condition when not in use (FIGS. 1 and 2) into a condition for use (FIGS. 3 and 4). In the condition when not in use, the container parts lie folded together essentially flat on or in the plane of the cargo hold bottom 2. In the condition for use, the assembled container parts form at least one holding compartment 4, which is open on the top.

The holding container 1 is preferably mounted via sliding guide means 6 in the cargo hold bottom 2 in such a way that it can be displaced—especially in the direction of a motor vehicle longitudinal axis X (see the double arrows shown in FIGS. 1 and 4)—between two positions. They are preferably a first sliding position according to FIGS. 1 and 4, wherein the holding container 1 is located very deep inside the cargo hold far from a cargo hold opening, in the vicinity of a partition wall of the cargo hold, as well as a second sliding position, wherein the holding container 1 is located in the vicinity of the cargo hold opening (FIGS. 2 and 3). This displacement is basically optionally possible between the condition when not in use or the condition for use of the holding container 1. As sliding guide means 6 is preferably used a traditional track system with two lateral guide tracks which are parallel to each other.

In another advantageous embodiment of the invention, the sliding guide means 6 are configured in such a way that the holding container 1 can be lowered into the cargo hold bottom 2 in its condition when not in use and especially in its first sliding position according to FIG. 1, so that it lies with an upper boundary plane (the surface of a cover part 12) approximately in the plane of the cargo hold bottom 2. This advantageous configuration makes possible in the condition when not in use of the holding container 1 an unimpeded normal use of the entire cargo hold in that the load can also be placed in the surface area of the holding container 1.

The holding container 1 is functionally releasably fixed in at least one, preferably however in the two sliding positions, via stop means (not shown).

In the shown preferred exemplary embodiment, the holding container 1 consists of a lower bottom part 10 and a cover part 12, which is hinge connected to the same in the manner of a case, as well as also wall parts 14, 16, 18, and 20, which are hinge connected to the cover part 12. In this way, the cover part 12 is joint connected to a front wall part 18 via at least two lateral wall parts 14 and 16 so that, via a parallelogram-like hinge movement, the wall parts 14 to 18 can be transferred from their flat superposed position lying on the inner side of the cover part 12 into a condition which forms the holding compartment 4 (as well as vice versa). The bottom part 10 forms in this way, together with the cover part 12, a kind of case in which, in the closed condition when not in use, the remaining wall parts are installed in a somewhat parallel superposed position. In the open mounted condition, the cover part 12 stands somewhat vertical to the bottom part 10, and the wall parts can be pivoted away from the cover part 12 in a parallelogram-like manner to form the holding compartment 4. In this way, the holding container 1 has a preferably elongated somewhat rectangular base shape, which extends across the motor vehicle longitudinal axis X and essentially over the entire width of the cargo hold.

In this way, for the transfer into the condition for use starting from the condition when not in use according to FIG. 1, first the entire flat-lying holding container 1 is pulled toward the direction of the cargo hold opening. Then, according to FIGS. 2 and 3, the cover part 12 is installed at an angle of about 90° and the wall parts are moved in parallelogram-like manner from the cover part 12 toward the direction of the cargo hold opening 1. In case of need, then, the entire assembled holding container 1 can be moved back, according to FIG. 4, even further away from the cargo hold opening and more deeply into the cargo hold. This allows a utilization of the area facing the cargo hold opening to accommodate larger loads.

It can also be preferred to provide at least one partition wall part 22 arranged between the lateral wall parts 14, 16. This partition wall part 22 is exclusively hinge connected either only to the cover part 12 or only to the front wall part 18, so that the holding compartment 4 can be optionally partitioned in that the partition wall part 22 is pivoted away when the holding container 1 is mounted. In its partitioned position takes place a functional fixing especially via suitable stop means in the area of its free pivotable wall edge.

It is also advantageous when the holding container 1 in its entirety, that is, together with the bottom part 10, is mounted especially via the sliding guide means 6 so that it can be pivoted up from the motor vehicle cargo hold bottom 2 to expose a compartment for a spare wheel on the side of the motor vehicle (not shown in the drawing).

Furthermore, a manipulating handle 24 is advantageously provided, which is preferably attached to the front wall part 18 in such a way that it lies in the area of an adaptably configured recess 26 of the cover part 12 (see FIGS. 1 and 2) in the condition when not in use. By means of this advantageous configuration, a one-handed operation is comfortably possible in that the manipulating handle 24, on the one hand, can be used to mount the cover part 12 and, on the other hand, can also be used for the parallelogram-like assembly displacement of the wall parts.

Finally, in FIG. 3 it can also be seen that preferably several hook elements 28 are arranged especially on the inside of the cover part 12 so that objects, for example, shopping bags, can also be fixed by hanging.

The holding container 1 according to the invention can also be equipped with additional devices such as an integrated cooler, a handle device, and/or the like.

By means of the invention are obtained fundamental advantages: a simplification of the transportation of any desired object, product, etc., a minimization of the possibility of displacement of the objects during acceleration and deceleration of the motor vehicle, a protection of the cargo hold from unclean products, an optimization of the accessibility and utilization of the entire cargo hold, and a general improvement of the loading and unloading behavior.

The invention is not limited to the shown and described exemplary embodiments but comprises also all of the embodiments with the same effect in the sense of the invention.

Priority application German Utility Model Application Number 200 09 661.3, filed May 30, 2000 is incorporated herein by reference in its entirety.

What is claimed is:

1. An arrangement for transporting objects in a motor vehicle comprising:
a holding container mounted on a cargo hold bottom of the motor vehicle, wherein the holding container includes a number of container parts, which are movably collapsibly connected to each other in such a way that the holding container is configured to be transferred from a condition when not in use, wherein the container parts lie essentially folded together flat on or in the plane of the cargo hold bottom, into a condition for use, wherein the assembled container parts form at least one holding compartment.

2. The arrangement according to claim 1 wherein the holding container is mounted via sliding guide means in such a way on the cargo hold bottom that it can be displaced between two positions.

3. The arrangement according to claim 2, wherein the sliding guide means are configured in such a way that the holding container in its condition when not in use can be lowered into the cargo hold bottom so that it lies with an upper boundary plane approximately in the plane of the cargo hold bottom.

4. The arrangement according to claim 2, wherein the holding container is releasably fixed in the two sliding positions via stop means.

5. The arrangement according to one of claim 1, wherein the holding container includes a lower bottom part and a cover part, which is hinge connected to said lower bottom part, and a number of wall parts which are hinge connected to the cover part.

6. The arrangement according to claim 5, wherein the cover part is hinge connected in such a way via at least two lateral wall parts to a front wall part that, via a parallelogram-like pivoting movement, the wall parts can be transferred from their flat superposed lying position into a condition whereby the holding compartment is formed, and vice versa.

7. The arrangement according to claim 6, further comprising:
at least one partition wall part, which is hinge connected to the cover part or the front wall part, arranged between the lateral wall parts.

8. The arrangement according to claim 7, further comprising:
a manipulating handle, which is preferably attached to the front wall part.

9. The arrangement according to claim 1, wherein the holding container is mounted on the motor vehicle cargo hold bottom so that the holding container can be pivoted up to expose a spare wheel compartment on the side of the motor vehicle.

10. The arrangement according to claim 1, further comprising:
at least one hook element, which is preferably arranged in such a way that objects can be fixed by hanging.
